(19) United States
(12) Patent Application Publication
(10) Pub. No.: US 2018/0201388 A1
(43) Pub. Date: Jul. 19, 2018

(54) HEAT MANAGING AND DISPERSING STRUCTURE AND UNMANNED AERIAL VEHICLE USING THE SAME

(71) Applicant: Graduate School at Shenzhen, Tsinghua University, Shenzhen (CN)

(72) Inventors: HONG-DA DU, Shenzhen (CN); WEI CHEN, Shenzhen (CN); JING-GUO YANG, Shenzhen (CN); LIN GAN, Shenzhen (CN); JIA LI, Shenzhen (CN); CHENG-JUN XU, Shenzhen (CN); XIAO-DONG CHU, Shenzhen (CN); YOU-WEI YAO, Shenzhen (CN); BAO-HUA LI, Shenzhen (CN); QUAN-HONG YANG, Shenzhen (CN); YAN-BING HE, Shenzhen (CN); FEI-YU KANG, Shenzhen (CN)

(21) Appl. No.: 15/491,628

(22) Filed: Apr. 19, 2017

(30) Foreign Application Priority Data
Jan. 19, 2017 (CN) 201710044630.2

(51) Int. Cl. B64D 33/08; F28F 13/18; F28D 15/02; B64C 39/02

(52) U.S. Cl. CPC B64D 33/08; F28F 13/18; F28D 2021/0021; F28D 15/02; B64C 39/024; F28D 15/0275

(57) ABSTRACT

A heat management structure able to disperse heat but also able to retain a proper working heat includes a heat dissipation layer, a receiving member, and a heat pipe. The receiving member is configured to receive a heating member. Ends of the heat pipe are coupled to the heat dissipation layer and the receiving member. A related unmanned aerial vehicle is also provided.

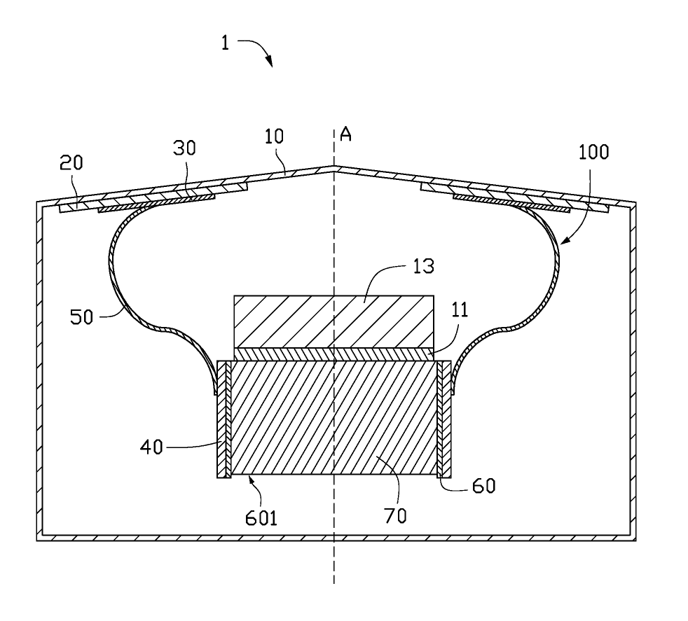

### FIELD

The subject matter herein generally relates to heat management structures.

### BACKGROUND

Unmanned aerial vehicles (UAVs) using batteries can be commonly used for industrial and commercial purposes, for example performing aerial photography, remote mapping, forest fireproofing, power line inspection, search and rescue missions, filming, advertisement, and the like. However, when the batteries are rapidly charged or have ran for a long time, temperatures of the batteries can be extremely high, and batteries even can undergo thermal runaway or explode. When the batteries are in a low temperature, resistance of the batteries can increase and the efficiency of the batteries can decrease, the batteries may not even work normally. Thus, the UAVs must each employ a heat management method to keep the temperature of the battery in a predetermined range.

### SUMMARY OF THE INVENTION

In accordance with a first aspect disclosed herein, a heat management structure to resolve the above problems is disclosed. A heat management structure can include at least one heat dissipation layer, a receiving member, and at least one heat pipe. The receiving member can be configured to receive at least one heating member. Two ends of the at least one heat pipe can be respectively coupled to the at least one heat dissipation layer and the receiving member.

In some exemplary embodiments, the at least one heat pipe includes two symmetrically distributed heat pipes.

In some exemplary embodiments, the at least one heat dissipation layer can be a graphite film.

In some exemplary embodiments, the heat management structure can further include at least one first heat conduction member and at least one second heat conduction member. The at least one first heat conduction member can be coupled to the at least one heat dissipation layer, the at least one second heat conduction member can be coupled to the receiving member. The two ends of the at least one heat pipe can be respectively coupled to the at least one heat dissipation layer and the receiving member respectively through the first heat conduction member and the second heat conduction member.

In some exemplary embodiments, the at least one first heat conduction member and the at least one second heat conduction member can each be made of aluminum or copper.

In some exemplary embodiments, a material of a pipe of the at least one heat pipe can be substantially same as a material of the at least one first heat conduction member, or a material of a pipe of the at least one heat pipe is substantially same as a material of the at least one second heat conduction member, or a material of a pipe of the at least one heat pipe is substantially same as a material of the at least one first heat conduction member and is substantially same as a material of the at least one second heat conduction member.

In some exemplary embodiments, the at least one first heat conduction member is adhered to the at least one heat dissipation layer, or the at least one second heat conduction member is adhered to the receiving member, or the at least one first heat conduction member is adhered to the at least one heat dissipation layer and the at least one second heat conduction member is adhered to the receiving member.

In some exemplary embodiments, the at least one heat pipe can be coupled to the at least one first heat conduction member and the at least one second heat conduction member by soldering.

In accordance with a second aspect disclosed, an unmanned aerial vehicle (UAV) is disclosed. The UAV can include a housing and a heat management structure. The heat management structure can include at least one heat dissipation layer, a receiving member, and at least one heat pipe. The at least one heat dissipation layer can be arranged on an inner surface of the housing. The receiving member can be configured to receive at least one heating member. Two ends of the at least one heat pipe can be respectively coupled to the at least one heat dissipation layer and the receiving member.

In some exemplary embodiments of the UAV, the at least one heat pipe includes two symmetrically distributed heat pipes.

In some exemplary embodiments of the UAV, the at least one heat dissipation layer can be a graphite film adhered to the housing.

In some exemplary embodiments of the UAV, the at least one heat dissipation layer can be a graphite layer coated on the housing to form a graphite film.

In some exemplary embodiments of the UAV, the heat management structure can further include at least one first heat conduction member and at least one second heat conduction member. The at least one first heat conduction member can be coupled to the at least one heat dissipation layer, and the at least one second heat conduction member can be coupled to the receiving member. The two ends of the at least one heat pipe can be respectively coupled to the at least one heat dissipation layer and the receiving member through the first heat conduction member and the second heat conduction member.

In some exemplary embodiments of the UAV, the at least one first heat conduction member and the at least one second heat conduction member can each be made of aluminum or copper.

In some exemplary embodiments of the UAV, a material of a pipe of the at least one heat pipe can be substantially same as a material of the at least one first heat conduction member, or a material of a pipe of the at least one heat pipe is substantially same as a material of the at least one second heat conduction member, or a material of a pipe of the at least one heat pipe is substantially same as a material of the at least one first heat conduction member and is substantially same as a material of the at least one second heat conduction member.

In some exemplary embodiments of the UAV, the at least one first heat conduction member can be adhered to the at least one heat dissipation layer, or the at least one second heat conduction member is adhered to the receiving member, or the at least one first heat conduction member is adhered to the at least one heat dissipation layer and the at least one second heat conduction member can be adhered to the receiving member.

In some exemplary embodiments of the UAV, the at least one heat pipe can be coupled to the at least one first heat conduction member and the at least one second heat conduction member by soldering.

In some exemplary embodiments of the UAV, the housing can be made of polymer material with higher specific heat capacity and larger surface area or polymer material with higher thermal conductivity.

In some exemplary embodiments of the UAV, an insulation material arranged between the housing and the receiving member is included, the insulation material can be configured to provide a heat insulating function.

The structure of the heat management structure can be compact, the heat dissipating effect of the heat management structure can be very high, and the heat management structure can be a passive and non-power-consuming structure.

### BRIEF DESCRIPTION OF THE DRAWING

Implementations of the present technology will now be described, by way of example only, with reference to the attached figure.

The figure is a cross-sectional view of a part of an UAV according to of an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

In general, the term “coupled” is defined as coupled, whether directly or indirectly through intervening components, and is not necessarily limited to physical connections. The connection can be such that the objects are permanently coupled or releasably coupled. The term “first” and “second” are used to distinguish between different objects, and not as a description in a particular order. The terms used in the disclosure are only used for explaining the detail exemplary embodiment, but not to limit the disclosure.

Exemplary embodiments of the present disclosure will be described with reference to the accompanying drawing.

The figure illustrates a cross-sectional view of an exemplary embodiment of a part of an unmanned aerial vehicle 1 (UAV 1). The UAV 1 can include a housing 10 and a heat management structure 100 arranged in the housing 10. The housing 10 can be an outer casing of the UAV 1. The heat management structure 100 can be configured to keep a temperature of at least one heating member 70 of the UAV 1 in a predetermined range, preventing the UAV 1 from reaching or maintaining at excessively high and excessively low temperatures.

In at least one exemplary embodiment, one heating member 70 can be employed as an example of a heat-producing element. In other exemplary embodiments, more than one heating member 70 can be employed. In at least one exemplary embodiment, the heating member 70 can be a battery. In an alternative exemplary embodiment, the heating member 70 can be a chip, an electronic equipment, and so on. In an alternative exemplary embodiment, the heat management structure 100 can be configured to keep the temperature of the heating member 70 of other equipment in a predetermined range. For example, keeping the temperature of the heating member of a robot, the heating member of an electronic device, or the heating member of other mechanical device (such as motor vehicle, plane, or the like) in a predetermined range. The heating member 70 can accordingly be the heating member of the robot, the heating member of the electronic device, or the heating member of other mechanical device. The housing 1 can accordingly be the housing of the robot, the housing of the electronic device, or the housing of other mechanical device.

In at least one exemplary embodiment, the UAV 1 can be also include other structures, for example, a circuit board 11. The housing 10 in the figure is only an illustration. The shape and the structure are not limited to those in the figure.

In at least one exemplary embodiment, the housing 10 can define a receiving space. The heat management structure 100 and other components (for example the circuit board 11) of the UAV 1 can be received in the receiving space of the housing 1. In at least one exemplary embodiment, the receiving space can be sealed from the external environment.

The heat management structure 100 can include at least one heat dissipation layer 20, at least one first heat conduction member 30, at least one second heat conduction member 40, at least one heat pipe 50, and a receiving member 60.

In at least one exemplary embodiment, two heat dissipation layers 20, two first heat conduction members 30, two second heat conduction members 40, and two heat pipes 50 can be used as an example. Two heat dissipation layers 20 can be symmetrically adhered on an inner surface of the housing 10 around a central axis A of the UAV 1. Each first heat conduction member 30 can be arranged on a corresponding heat dissipation layer 20. Two second heat conduction members 40 can be arranged on opposite sidewalls of the receiving member 60. One heat pipe 50 can be coupled between one first heat conduction member 30 and one second heat conduction member 40 arranged at one side of the central axis A, as a mirror image of the previous arrangement on the other side. The two heat pipes 50 can be symmetrically distributed. The receiving member 60 can be configured to receive the heating member 70.

In an alternative exemplary embodiment, the two heat dissipation layers 20 can be asymmetrically distributed on the inner surface of the housing 10. In an alternative exemplary embodiment, the two second heat conduction members 40 can be asymmetrically distributed. In an alternative exemplary embodiment, the two heat pipes 50 can be asymmetrically distributed. In an alternative exemplary embodiment, the number of the heat dissipation layers 20, the first heat conduction members 30, the second heat conduction members 40, and the heat pipes 50 can also be one, three, or more than three. In an alternative exemplary embodiment, the numbers of the heat dissipation layers 20, of the first heat conduction members 30, of the second heat conduction members 40, and of the heat pipes 50 can be different. For example, the number of the heat dissipation layers 20, the first heat conduction members 30, and the second heat conduction members 40 can all be one, but the number of the heat pipes 50 can be two. Thus, each heat pipe 50 can be coupled between the first heat conduction member 30 and the second heat conduction member 40.

In at least one exemplary embodiment, the housing 10 can be made of polymer material with higher specific heat capacity and larger surface area. The housing 10 can be configured to absorb the heat transmitted from the heat dissipation layer 20. In an alternative exemplary embodiment, the housing 10 can be made of polymer material with higher thermal conductivity, thus the strength and the processing performance of the housing 10 can be improved. In at least one exemplary embodiment, the UAV 1 can further include insulation material 13. The insulation material 13 can be configured to provide heat insulation effects. The insulation material 13 and the circuit board 11 can be arranged on one or more surfaces of the receiving member 60 excluding the opposite sidewalls, and can be arranged between the housing 10 and the receiving member 60. In an alternative exemplary embodiment, the insulation material 13 can be omitted. In an alternative exemplary embodiment, the circuit board 11 can be arranged on one or more surfaces of the receiving member 60 excluding the opposite sidewalls, and can be arranged between the housing 10 and the receiving member 60.

In at least one exemplary embodiment, the heat dissipation layer 20 can be a graphite film adhered to the housing 10, with a higher heat conductive performance. The heat can rapidly flow from a higher temperature area of the heat dissipation layer 20 to a lower temperature area of the heat dissipation layer 20. Thus, the heat dissipation layer 20 can provide heat conducting and heat equalizing function. In an alternative exemplary embodiment, the heat dissipation layer 20 can be a graphite layer coated on a surface of the housing 10 to form a graphite film. In an alternative exemplary embodiment, the heat dissipation layer 20 can be other heat dissipation layer with a higher heat conductive function, it is not limited to the graphite film of the present exemplary embodiment.

In at least one exemplary embodiment, the first heat conduction member 30 and the second heat conduction member 40 can each be a metal foil. The metal foil can be made of aluminum or copper. Because of the higher thermal conductivity of the aluminum material or the copper material, the first heat conduction member 30 and the second heat conduction member 40 can each provide a heat conducting and heat equalizing function. The first heat conduction member 30 can be adhered to the heat dissipation layer 20 through glue, and/or the second heat conduction member 40 can be adhered to the receiving member 60 through glue. In an alternative exemplary embodiment, the first heat conduction member 30 and the second heat conduction member 40 can be made of other heat-conductive material, such as silver, and so on. The first heat conduction member 30 can be fixed to the heat dissipation layer 20 and/or the second heat conduction member 40 can be fixed to the receiving member 60 in the other manners. For example, by an injection molding method, thus the first heat conduction member 30 and the heat dissipation layer 20, and/or the second heat conduction member 40 and the receiving member 60 can be integrally formed.

In at least one exemplary embodiment, a shape of each heat pipe 50 can be substantially curved and flat. The shape of each heat pipe 50 is not limited to the substantially curved and flat, but also can be other shape, for example, cylindrical, or the like. The shape of the heat pipes 50 can be different according to a distribution of the components inside the UAV 1, thus the heat management structure 100 can be a compact installation. The heat pipes 50 can each bypass the circuit board 11 and/or the insulation material 13, and each heat pipe 50 can be coupled to a first heat conduction member 30 and a second heat conduction member 40. In at least one exemplary embodiment, the heat pipes 50 can each be coupled in this way by soldering. In an alternative exemplary embodiment, the heat pipes 50 can each be coupled in this way by other means. For example, riveting, screwing, docking, or the like.

A material of each heat pipe 50 can be substantially same as a material of the corresponding first heat conduction member 30 and a material of the corresponding second heat conduction member 40. The material of the pipe of each heat pipe 50 can be also made of aluminum material or copper material. Thus, thermal resistances at the interfaces between each heat pipe 50 and the corresponding first and second heat conduction members 30 and 40 can be decreased, and the heat transfer efficiencies between each heat pipe 50 and the members 30 and 40 can be accordingly improved. It will be appreciated that, the heat pipes 50 can each be a heat-transfer device that combines the principles of both thermal conductivity and phase transition to rapidly transfer the heat from a heat source out of the heat source. That is, the heat pipes 50 can each transfer the heat from one end to another end depending on the higher heat conductivity function of the heat pipe 50. Moreover, the heat transfer by each heat pipe 50 can be greatly reduced when at a low temperature, thus the heat pipes 50 can each provide heat insulating function.

In at least one exemplary embodiment, the receiving member 60 can be a hollow cuboid or a hollow cube with an opening 601 at one end. The shape of the receiving member 60 is not limited to the hollow cuboid or the hollow cube, but also can be a hollow cylinder, or the like. The opening can be defined at the one or more surfaces of the receiving member 60 and be adjacent to the insulation material 13 or the circuit board 11. The opening of the receiving member 60 is not limited to being defined at the above position, but also can be defined at one or more sidewalls of the receiving member 60. In an alternative exemplary embodiment, the opening can be omitted.

In an alternative exemplary embodiment, a thickness and an area of each heat dissipation layer 20, each first heat conduction member 30, and each second heat conduction member 40 can be changed. The material of each first heat conduction member 30, each second heat conduction member 40, and each heat pipe 50 can also be changed, thus different heat management requirements can be met. In an alternative exemplary embodiment, the first heat conduction members 30 and the second heat conduction members 40 can be omitted, and the heat pipes 50 can each be directly or indirectly coupled between the receiving member 60 and the heat dissipation layer 20.

In at least one exemplary embodiment, the receiving member 60, one second heat conduction member 40, one heat pipe 50, one first heat conduction member 30, one heat dissipation layer 20, and the housing 10 can be coupled in sequence to form a heat dissipation path. The receiving member 60, the other second heat conduction member 40, the other heat pipe 50, the other first heat conduction member 30, the other heat dissipation layer 20, and the housing 10 can be coupled in sequence to form another heat dissipation path. When the heating member 70 is at work or needs to dissipate heat, the heat of the heating member 70 can be transmitted to the second heat conduction members 40 adhered to the sidewalls of the receiving member 60 through the receiving member 60. Then the heat at the second heat conduction members 40 can be transmitted to the heat pipes 50 coupled to the second heat conduction members 40 through the second heat conduction members 40. Next, the heat at the heat pipes 50 can be transmitted to the first heat conduction members 30 that are coupled to the heat pipes 50, the heat at the first heat conduction members 30 can be transmitted to the heat dissipation layers 20 that are coupled to the first heat conduction members 30, and the heat at the heat dissipation layers 20 transmitted to the housing 10 that is adhered to the heat dissipation layers 20. Next, the heat at the housing 10 can be transmitted to the exterior through air convection between the housing 10 and the external environment. Moreover, when the heating member 70 is not at work or is working at an environment at a low temperature, because the heat transfer by each heat pipe 50 can be greatly reduced when being at a low temperature, the heat pipes 50 can each provide insulating functions, thus, the heating member 70 can be kept at the predetermined temperature.

The heat management structure 100 can function so as to combine the heat conducting and the heat equalizing functions. Heat generated by the heating member 70 can be transmitted to the housing 10 of the UAV 1, and the heat transmitted to the housing 10 can be dissipated through convection depending on the higher specific heat capacity and the larger specific area. Simultaneously, because the heat transfer by each heat pipe 50 can be greatly reduced under a low temperature, the heat management structure 100 can also provide an insulating function for the heating member 70. As compared to related art that defines one or more vents at one or more compartments that receive the heating member 70, or installs one or more fans to dissipate heat through convection, the structure of the heat management structure 100 in the present disclosure can be compact. The heat dissipating effect of the heat management structure 100 in the present disclosure is effective. The heat management structure 100 of the present disclosure being sealed, an adverse environment is of no effect, and the steady operation and the safety of the UAV 1 can be ensured.

The term “comprising,” when utilized, means “including, but not necessarily limited to”; it specifically indicates open-ended inclusion or membership in the so-described combination, group, series, and the like.

Certain features of the disclosure described in the context of separate exemplary embodiments, may also be provided in combination in a single exemplary embodiment. Conversely, various features of the disclosure described in the context of a single exemplary embodiment, may also be provided separately or in any suitable subcombination or as suitable in any other described exemplary embodiment of the disclosure. Certain features described in the context of various exemplary embodiments are not to be considered essential features of those exemplary embodiments, unless the exemplary embodiment is inoperative without those elements.

Although the invention has been described in conjunction with specific exemplary embodiments thereof, it is evident that many alternatives, modifications and variations will be apparent to those skilled in the art. Accordingly, it is intended to embrace all such alternatives, modifications, and variations that fall within the spirit and broad scope of the appended claims.

What is claimed is:

1. A heat management structure comprising:
at least one heat dissipation layer;
a receiving member configured to receive at least one heating member; and
at least one heat pipe having two ends respectively being coupled to the at least one heat dissipation layer and the receiving member.

2. The heat management structure as described in claim 1, wherein:
the at least one heat pipe comprises two symmetrically distributed heat pipes.

3. The heat management structure as described in claim 1, wherein:
the at least one heat dissipation layer is a graphite film.

4. The heat management structure as described in claim 1, wherein:
the heat management structure further comprises at least one first heat conduction member and at least one second heat conduction member, the at least one first heat conduction member is coupled to the at least one heat dissipation layer, the at least one second heat conduction member is coupled to the receiving member; and
the two ends of the at least one heat pipe are respectively coupled to the at least one heat dissipation layer and the receiving member respectively through the first heat conduction member and the second heat conduction member.

5. The heat management structure as described in claim 4, wherein:
the at least one first heat conduction member and the at least one second heat conduction member each is made of aluminum or copper.

6. The heat management structure as described in claim 5, wherein:
a material of a pipe of the at least one heat pipe is substantially same as a material of the at least one first heat conduction member, or a material of a pipe of the at least one heat pipe is substantially same as a material of the at least one second heat conduction member, or a material of a pipe of the at least one heat pipe is substantially same as a material of the at least one first heat conduction member and is substantially same as a material of the at least one second heat conduction member.

7. The heat management structure as described in claim 4, wherein:
the at least one first heat conduction member is adhered to the at least one heat dissipation layer, or the at least one second heat conduction member is adhered to the receiving member, or the at least one first heat conduction member is adhered to the at least one heat dissipation layer and the at least one second heat conduction member is adhered to the receiving member.

8. The heat management structure as described in claim 4, wherein:
the at least one heat pipe is coupled to the at least one first heat conduction member and the at least one second heat conduction member by soldering.

9. An unmanned aerial vehicle comprising:
a housing; and
a heat management structure comprising:
at least one heat dissipation layer arranged on an inner surface of the housing;
a receiving member configured to receive at least one heating member; and
at least one heat pipe having two ends respectively coupled to the at least one heat dissipation layer and the receiving member.

10. The unmanned aerial vehicle as described in claim 9, wherein:
the at least one heat pipe comprises two symmetrically distributed heat pipes.

11. The unmanned aerial vehicle as described in claim 9, wherein:
the at least one heat dissipation layer is a graphite film adhered to the housing.

12. The unmanned aerial vehicle as described in claim 9, wherein:
the at least one heat dissipation layer is a graphite layer coated on the housing to form a graphite film.

13. The unmanned aerial vehicle as described in claim 9, wherein:
the heat management structure further comprises at least one first heat conduction member and at least one second heat conduction member, the at least one first heat conduction member is coupled to the at least one heat dissipation layer, the at least one second heat conduction member is coupled to the receiving member; and
the two ends of the at least one heat pipe are respectively coupled to the at least one heat dissipation layer and the receiving member respectively through the first heat conduction member and the second heat conduction member.

14. The unmanned aerial vehicle as described in claim 13, wherein:
the at least one first heat conduction member and the at least one second heat conduction member each is made of aluminum or copper.

15. The heat management structure as described in claim 14, wherein:
a material of a pipe of the at least one heat pipe is substantially same as a material of the at least one first heat conduction member, or a material of a pipe of the at least one heat pipe is substantially same as a material of the at least one second heat conduction member, or a material of a pipe of the at least one heat pipe is substantially same as a material of the at least one first heat conduction member and is substantially same as a material of the at least one second heat conduction member.

16. The unmanned aerial vehicle as described in claim 13, wherein:
the at least one first heat conduction member is adhered to the at least one heat dissipation layer, or the at least one second heat conduction member is adhered to the receiving member, or the at least one first heat conduction member is adhered to the at least one heat dissipation layer and the at least one second heat conduction member is adhered to the receiving member.

17. The unmanned aerial vehicle as described in claim 13, wherein:
the at least one heat pipe is coupled to the at least one first heat conduction member and the at least one second heat conduction member by soldering.

18. The unmanned aerial vehicle as described in claim 9, wherein:
the housing is made of polymer material with higher specific heat capacity and larger surface area or polymer material with higher thermal conductivity.

19. The unmanned aerial vehicle as described in claim 9, wherein:
the unmanned aerial vehicle further comprises an insulation material arranged between the housing and the receiving member, the insulation material is configured to provide a heat insulating function.
